(19) United States
(12) Patent Application Publication
(10) Pub. No.: US 2025/0367871 A1
(43) Pub. Date: Dec. 4, 2025

(54) THREE-DIMENSIONAL MODELING DEVICE

(71) Applicant: SEIKO EPSON CORPORATION, Tokyo (JP)

(72) Inventors: Kota NOGUCHI, MATSUMOTO-SHI (JP); Tatsuya TERAMOTO, SHIOJIRI-SHI (JP)

(21) Appl. No.: 19/218,726

(22) Filed: May 27, 2025

(30) Foreign Application Priority Data
May 29, 2024 (JP) 2024-086827

(51) Int. Cl. B29C 64/118; B29C 64/209; B29C 64/295; B29C 64/386; B33Y 30/00; B33Y 50/00

(52) U.S. Cl. CPC B29C 64/118; B29C 64/209; B29C 64/295; B29C 64/386; B33Y 30/00; B33Y 50/00

(57) ABSTRACT

A three-dimensional modeling device includes a first heating unit including a heating surface that heats a plasticized material stacked on a stage, a measurement unit including a first sensor that measures a position of the heating surface, and a control unit. The heating surface includes a first heating region and a second heating region, the first heating unit includes a first heater part and a second heater part, and the control unit executes first processing for setting an output of the first heater part lower than an output of the second heater part when it is determined, based on measurement of a position of the heating surface, that a distance between the first heating region and the stage is a first distance and a distance between the second heating region and the stage is a second distance larger than the first distance.

The present application is based on, and claims priority from JP Application Serial Number 2024-086827, filed May 29, 2024, the disclosure of which is hereby incorporated by reference herein in its entirety.

### BACKGROUND

### 1. Technical Field

The present disclosure relates to a three-dimensional modeling device.

### 2. Related Art

A three-dimensional modeling device disclosed in JP-A-2022-170965 includes a heating unit that heats a modeling material stacked in a modeling region of a stage. The heating unit has a shape covering the modeling region.

There has been a demand for a technique capable of suppressing heating unevenness when the heating unit heats a modeling object.

### SUMMARY

According to a first mode of the present disclosure, a three-dimensional modeling device is provided. The three-dimensional modeling device including a plasticizing unit configured to plasticize a material to generate a plasticized material, a nozzle configured to eject the plasticized material, a stage including a modeling surface on which the plasticized material is stacked, a moving unit configured to change a relative position between the nozzle and the stage, a first heating unit including a heating surface configured to heat the plasticized material stacked on the stage and having a plate-like shape in which a through hole is formed, at least a part of the nozzle being positioned inside the through hole during modeling of a three-dimensional object, a measurement unit including a first sensor configured to measure a position of the heating surface, and a control unit, wherein the heating surface includes a first heating region and a second heating region, the first heating unit includes a first heater part arranged corresponding to the first heating region and a second heater part arranged corresponding to the second heating region, and the control unit executes first processing for setting an output of the first heater part lower than an output of the second heater part when it is determined, based on measurement of a position of the heating surface, that a distance between the first heating region and the stage is a first distance and a distance between the second heating region and the stage is a second distance larger than the first distance.

According to a second mode of the present disclosure, a three-dimensional modeling device is provided. The three-dimensional modeling device includes a plasticizing unit configured to plasticize a material to generate a plasticized material, a nozzle configured to eject the plasticized material, a stage including a modeling surface on which the plasticized material is stacked, a moving unit configured to change a relative position between the nozzle and the stage, a first heating unit including a heating surface configured to heat the plasticized material stacked on the stage and having a plate-like shape in which a through hole is formed, at least a part of the nozzle being positioned inside the through hole during modeling of a three-dimensional object, a measurement unit including a second sensor configured to measure a temperature of the heating surface, an adjustment mechanism configured to adjust a posture of the first heating unit, and a control unit, wherein the heating surface includes a first heating region and a second heating region, the first heating unit includes a first heater part arranged corresponding to the first heating region and a second heater part arranged corresponding to the second heating region, and, when it is determined, based on measurement of a temperature of the heating surface, that a temperature of the first heating region is higher than a temperature of the second heating region, the control unit executes second processing for controlling the adjustment mechanism so that a distance between the first heating region and the stage is larger than a distance between the second heating region and the stage.

### BRIEF DESCRIPTION OF THE DRAWINGS

FIG. 1 is a first diagram illustrating a schematic configuration of a three-dimensional modeling device.

FIG. 2 is a second diagram illustrating a schematic configuration of the three-dimensional modeling device.

FIG. 3 is a perspective view illustrating a schematic configuration of a screw.

FIG. 4 is a schematic plan view of a barrel.

FIG. 5 is a perspective view illustrating a schematic configuration of a first heating unit and a first supporting unit.

FIG. 6 is an explanatory view illustrating a schematic configuration of the first heating unit and a first sensor.

FIG. 7 is a flowchart of three-dimensional modeling processing.

FIG. 8 is an explanatory diagram of heater output setting processing.

FIG. 9 is an explanatory diagram illustrating a schematic configuration of a first heating unit and a second sensor of a second embodiment.

FIG. 10 is a flowchart of three-dimensional modeling processing of the second embodiment.

FIG. 11 is an explanatory diagram of posture adjustment processing.

FIG. 12 is an explanatory diagram illustrating a schematic configuration of a first heating unit and a first sensor of a third embodiment.

FIG. 13 is a diagram illustrating a state in which a first distance is smaller than a second distance.

FIG. 14 is a diagram illustrating a state in which the first distance is larger than the second distance.

### DESCRIPTION OF EMBODIMENTS

### A. First Embodiment

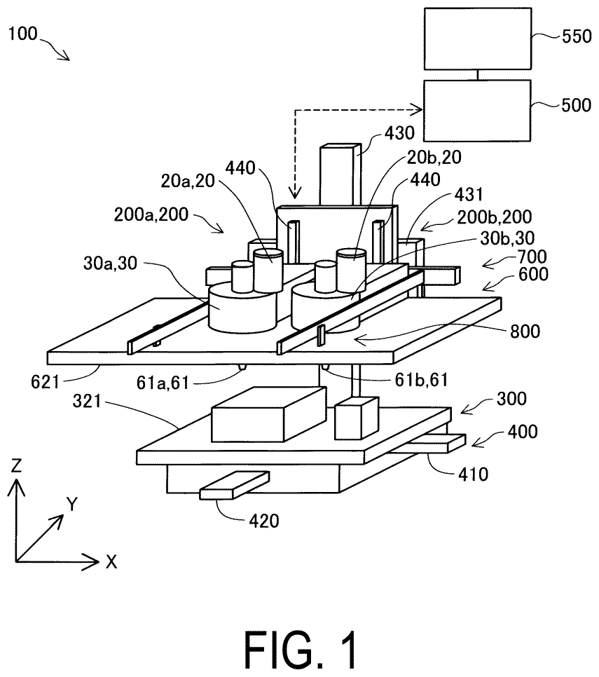

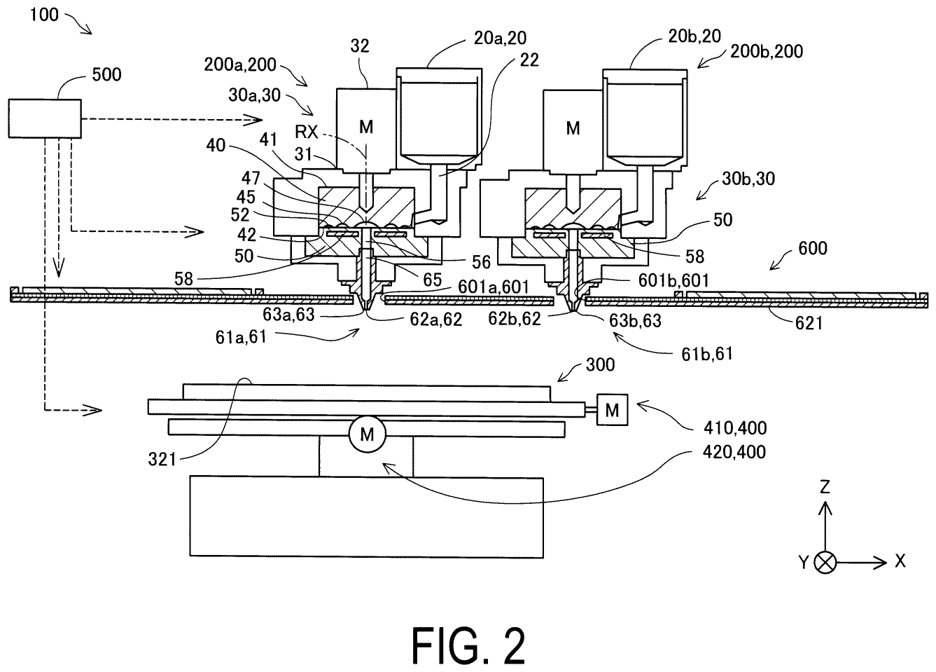

FIG. 1 is a first diagram illustrating a schematic configuration of a three-dimensional modeling device 100 of a first embodiment. FIG. 2 is a second diagram illustrating a schematic configuration of the three-dimensional modeling device 100 of the first embodiment. In FIG. 1 and FIG. 2, arrows along X, Y, and Z directions orthogonal to one another are illustrated. The X, Y, and Z directions are directions along an X axis, a Y axis, and Z axis, which are three spatial axes orthogonal to one another, and include both directions along the X axis, the Y axis, and the Z axis and directions opposite thereto, respectively. The X axis and the Y axis are axes along a horizontal plane, and the Z axis is an axis along a vertical line. A −Z direction is a vertical direction, and a +Z direction is a direction opposite to the vertical direction. The −Z direction is also referred to as “down”, and the +Z direction is also referred to as “up”. In the other drawings, the arrows along the X, Y, and Z directions are also illustrated as appropriate. The X, Y, and Z directions in FIG. 1 and FIG. 2 and the X, Y, and Z directions in the other drawings indicate the same directions.

The three-dimensional modeling device 100 includes a modeling unit 200, a stage 300, a moving unit 400, a control unit 500, a first heating unit 600, and a first supporting unit 700 including an adjustment mechanism 800.

The control unit 500 is a control device that controls an operation of the three-dimensional modeling device 100 as a whole. The control unit 500 is configured by a computer including one or a plurality of processors, a memory, an input/output interface that inputs and outputs a signal with an external device. A display unit 550 is connected to the control unit 500. A processor executes a program or a command that is read in a main storage device. With this, the control unit 500 executes three-dimensional modeling processing described later. Note that the control unit 500 may be achieved by a configuration obtained by combining a plurality of circuits for achieving at least a part of each function, instead of being configured by a computer.

Under control of the control unit 500, the modeling unit 200 ejects a plasticized material on the stage 300 for modeling that serves as a base table for a three-dimensional modeling object. The plasticized material is obtained by plasticizing a solid material into a paste form. The modeling unit 200 includes a material supply unit 20 that is a supply source of a material before being converted into the plasticized material, a plasticizing unit 30 that generates the plasticized material by plasticizing the material, and a nozzle 61 that ejects the plasticized material being generated. The modeling unit 200 is also referred to as a head.

The three-dimensional modeling device 100 of the embodiment includes a first modeling unit 200a and a second modeling unit 200b as the modeling unit 200. The first modeling unit 200a includes a first material supply unit 20a as the material supply unit 20, includes a first plasticizing unit 30a as the plasticizing unit 30, and includes a first nozzle 61a as the nozzle 61. The second modeling unit 200b includes a second material supply unit 20b as the material supply unit 20, includes a second plasticizing unit 30b as the plasticizing unit 30, and includes a second nozzle 61b as the nozzle 61. The first modeling unit 200a and the second modeling unit 200b are arranged to be arrayed in the X direction so that the position of the first nozzle 61a in the Y direction and the position of the second nozzle 61b in the Y direction match with each other. In the embodiment, the second modeling unit 200b is arranged at the position of the first modeling unit 200a in the X direction. The configuration of the first modeling unit 200a and the configuration of the second modeling unit 200b are similar to each other. Thus, in the following description, when no distinction is particularly made between the two units, those may simply be referred to as the modeling unit 200. Further, when distinction is made between the two constituent members, the constituent member of the first modeling unit 200a is denoted with the reference symbol “a”, and the constituent member of the second modeling unit 200b is denoted with the reference symbol “b”.

The material in a pellet form or a powder form is stored in the material supply unit 20. In the embodiment, an ABS resin formed in a pellet form is used as a material. The material supply unit 20 of the embodiment is configured by a hopper. As illustrated in FIG. 2, a supply path 22 that couples the material supply unit 20 and the plasticizing unit 30 to each other is provided in the lower part of the material supply unit 20. The material supply unit 20 supplies the material to the plasticizing unit 30 via the supply path 22.

As illustrated in FIG. 2, the plasticizing unit 30 includes a screw case 31, a driving motor 32, a screw 40, and a barrel 50. The plasticizing unit 30 plasticizes at least a part of the material supplied from the material supply unit 20, generates the plasticized material in a paste form having fluidity, and supplies the plasticized material to the nozzle 61. “Plasticization” is a concept that includes melting, and refers to changing a solid into a state with fluidity. Specifically, for a material that undergoes glass transition, plasticization refers to raising a temperature of the material above the glass transition point. For a material that does not undergo glass transition, plasticization refers to raising a temperature of the material above the melting point.

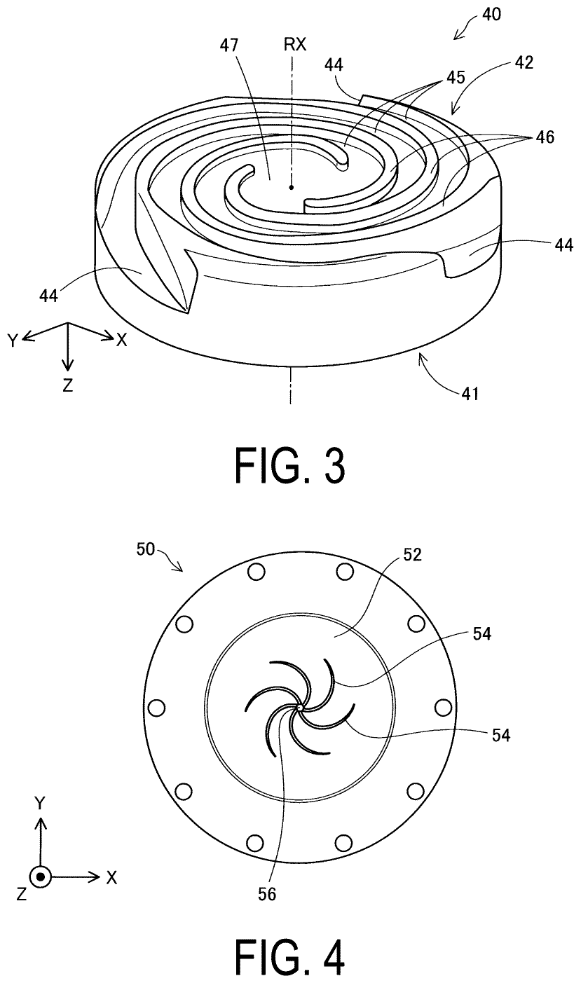

FIG. 3 is a perspective view illustrating a schematic configuration on a side of a screw lower surface 42 of the screw 40. FIG. 4 is a schematic plan view illustrating a side of a barrel upper surface 52 of the barrel 50. The screw 40 of the embodiment is a flat screw having a substantially columnar shape whose length in an axial direction being a direction along a center axis RX is smaller than its length in a direction orthogonal to the axial direction. The screw 40 is arranged so that the center axis RX being a rotation center thereof is parallel to the Z axis. The screw 40 is also referred to as a rotor or a scroll.

As illustrated in FIG. 2, the screw 40 is accommodated in the screw case 31. The driving motor 32 is coupled to a screw upper surface 41 of the screw 40, and the screw 40 rotates inside the screw case 31 by a rotation driving force generated by the driving motor 32. The driving motor 32 is driven under control of the control unit 500. Note that the screw 40 may be driven by the driving motor 32 via a reducer.

As illustrated in FIG. 3, in the screw lower surface 42, a spiral groove portion 45 is formed. The supply path 22 of the material supply unit 20 described above communicates with the groove portion 45 from the side surface of the screw 40. The groove portion 45 is continuous with a material inlet 44 formed in the side surface of the screw 40. The material inlet 44 is a portion that receives the material supplied via the supply path 22 of the material supply unit 20. As illustrated in FIG. 3, in the embodiment, three groove portions 45 are formed by being separated by protrusion portions 46. Note that the number of groove portions 45 is not limited to three, and may be one, two, or more. The groove portion 45 is not limited to a spiral shape, and may be a helical shape, an involute curved shape, or a shape extending in an arc from a center portion 47 toward the outer periphery.

As illustrated in FIG. 2, the barrel 50 is arranged below the screw 40. The barrel upper surface 52 faces the screw lower surface 42, and a space is formed between the groove portion 45 of the screw lower surface 42 and the barrel upper surface 52. On the center axis RX of the screw 40, a communication hole 56 communicating with a nozzle flow path 65 of the nozzle 61, which is described later, is provided in the barrel 50. In the barrel 50, at a position facing the groove portion 45 of the screw 40, a second heating unit 58 for heating the material in the groove portion 45 is installed. A temperature of the second heating unit 58 is controlled by the control unit 500.

As illustrated in FIG. 4, a plurality of guide grooves 54 are formed in the periphery of the communication hole 56 in the barrel upper surface 52. One end of each of the guide grooves 54 is coupled to the communication hole 56, and extends spirally from the communication hole 56 toward the outer periphery of the barrel upper surface 52. Each of the guide grooves 54 has a function of guiding the plasticized material to the communication hole 56. Note that the one end of the guide groove 54 may not be coupled to the communication hole 56. Further, the guide groove 54 may not be formed in the barrel 50.

The material supplied into the groove portion 45 of the screw 40 is plasticized in the groove portion 45, flows along the groove portion 45 by rotation of the screw 40, and is guided as the plasticized material to the center portion 47 of the screw 40. The plasticized material that flows into the center portion 47 and is in a paste form exerting fluidity is supplied to the nozzle 61 via the communication hole 56. Note that not all types of substances constituting the plasticized material may not be plasticized. The plasticized material may be converted into a state having fluidity as a whole by plasticizing at least some types of substances constituting the plasticized material.

As illustrated in FIG. 2, the nozzle 61 includes the nozzle flow path 65 and a distal end surface 63 provided with a nozzle opening 62. The nozzle flow path 65 is a flow path that is formed in the nozzle 61 for the plasticized material, and is coupled to the communication hole 56 of the barrel 50 described above. The distal end surface 63 is a surface forming a distal end portion of the nozzle 61, the distal end portion protruding in the-Z direction toward the stage 300. The nozzle opening 62 is a portion that is provided to the nozzle flow path 65 on a side communicating with the ambient air and is obtained by reducing the flow path cross section of the nozzle flow path 65. A first nozzle opening 62a is formed in a first distal end surface 63a of the first nozzle 61a, and a second nozzle opening 62b is formed in the second distal end surface 63b of the second nozzle 61b. The plasticized material generated by the plasticizing unit 30 is supplied to the nozzle 61 via the communication hole 56, and is ejected from the nozzle opening 62 via the nozzle flow path 65.

The stage 300 is arranged at a position facing the nozzle opening 62. The three-dimensional modeling device 100 models the three-dimensional modeling object by causing the nozzle opening 62 to eject the plasticized material onto a modeling surface 321 of the stage 300 and stacking a layer of the plasticized material on the modeling surface 321. The layer of the plasticized material stacked on the modeling surface 321 is also referred to as a modeling layer.

The moving unit 400 changes a relative position between the nozzle 61 and the stage 300. In the embodiment, the moving unit 400 changes the relative position between the nozzle 61 and the stage 300 by moving the modeling unit 200 along the Z direction being a stacking direction and moving the stage 300 in a direction intersecting with the stacking direction. More specifically, the moving unit 400 of the embodiment changes the relative position between the nozzle 61 and the stage 300 in the Z direction by moving the modeling unit 200 along the Z direction, and changes the relative position between the nozzle 61 and the stage 300 in the X direction and the Y direction by moving the stage 300 in the X direction and the Y direction that are orthogonal to the Z direction. As illustrated in FIG. 1, the moving unit 400 is configured by a first electric actuator 410 that moves the stage 300 along the X direction, a second electric actuator 420 that moves the stage 300 and the first electric actuator 410 along the Y direction, and a third electric actuator 430 that moves the modeling unit 200 along the Z direction. More specifically, the third electric actuator 430 moves the first modeling unit 200a and the second modeling unit 200b along the Z direction by moving, along the Z direction, a movable portion 431 to which the first modeling unit 200a and the second modeling unit 200b are fixed. The first electric actuator 410, the second electric actuator 420, and the third electric actuator 430 are driven under control of the control unit 500. Note that, in FIG. 2, the third electric actuator 430 and the movable portion 431 are omitted.

As illustrated in FIG. 1, the first supporting unit 700 is also fixed to the movable portion 431. The first supporting unit 700 arranges the first heating unit 600 at a position facing the stage 300 by supporting the first heating unit 600 having a plate-like shape. Therefore, the third electric actuator 430 of the embodiment moves the first supporting unit 700 along the Z direction together with the modeling unit 200 while maintaining the positional relationship between the modeling unit 200 and the first supporting unit 700. In other words, it can also be described that the relative position of the first supporting unit 700 with respect to the stage 300 is changed together with that of the nozzle 61. Further, similarly, it can also be described that the relative position of the first heating unit 600 supported by the first supporting unit 700 with respect to the stage 300 is changed together with that of the nozzle 61. Note that, in FIG. 2, the first supporting unit 700 is omitted.

As described above, in the embodiment, the moving unit 400 moves the modeling unit 200 along the Z direction being the stacking direction, and moves the stage 300 in the direction intersecting with the stacking direction. In contrast, in another embodiment, for example, the moving unit 400 may move the stage 300 in the Z direction and move the modeling unit 200 along the X direction and the Y direction, may move the stage 300 along the X direction, the Y direction, and the Z direction without moving the modeling unit 200, or may move the modeling unit 200 along the X direction, the Y direction, and the Z direction without moving the stage 300. Note that, in the following description, the change of the relative position of the nozzle 61 with respect to the stage 300 may simply be referred to as movement of the nozzle 61. In the embodiment, for example, moving the stage 300 in the X direction with respect to the nozzle 61 may also be expressed as moving the nozzle 61 in the −X direction. Further, similarly, the change of the relative position of the modeling unit 200, the first heating unit 600, or the first supporting unit 700 with respect to the stage 300 may simply be referred to as movement of the modeling unit 200, the first heating unit 600, or the first supporting unit 700.

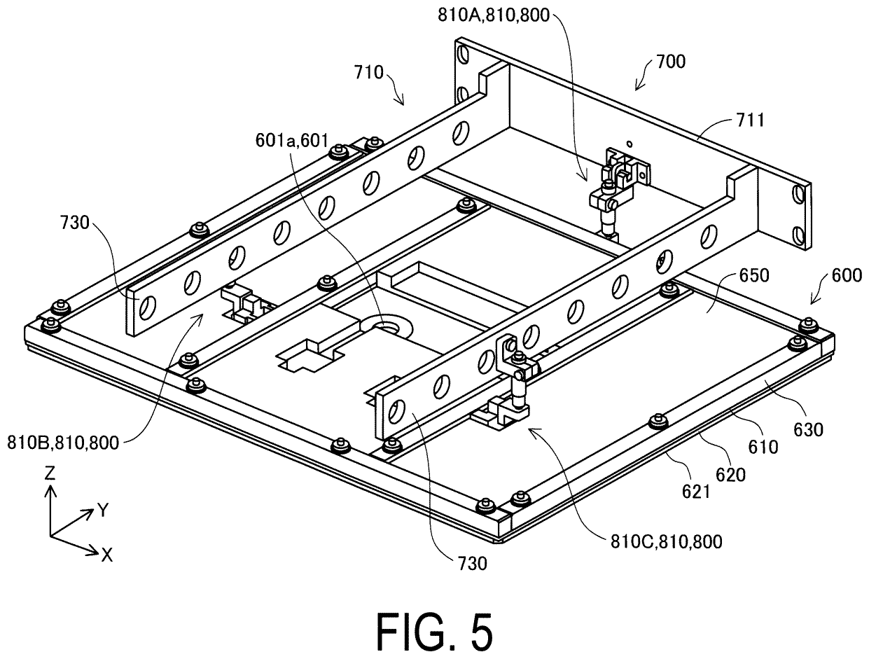

FIG. 5 is a perspective view of a schematic configuration of the first heating unit 600 and the first supporting unit 700 of the embodiment. The first heating unit 600 includes a heating plate 620, a frame portion 630 supporting the heating plate 620, and a first heater 610.

A through hole 601 is formed in the first heating unit 600. The through hole 601 passes through the first heating unit 600 in a direction orthogonal to the surface direction. As illustrated in FIG. 2, in the embodiment, a first through hole 601a and a second through hole 601b are formed as the through holes 601 in the first heating unit 600. The first through hole 601a and the second through hole 601b are formed in a center portion of the first heating unit 600 in the Y direction. The second through hole 601b is formed on the +X side of the first through hole 601a. In the following description, when no distinction is particularly made between the first through hole 601a and the second through hole 601b, those are also referred to simply as the through hole 601. A hole that is formed to pass through the first heater 610 in the Z direction and a hole that is formed to pass through the heating plate 620 in the Z direction are continuous in the Z direction. In this manner, the through hole 601 is formed.

At least a part of the nozzle 61 is positioned in the through hole 601 as illustrated in FIG. 2 when the plasticized material is ejected to model the three-dimensional modeling object. In FIG. 2, as viewed along the Z direction, it can also be described that the periphery of the nozzle 61 is surrounded by the first heating unit 600. In the embodiment, at the time of modeling the three-dimensional modeling object, the nozzle opening 62 is arranged between a heating surface 621 and the modeling surface 321 in the Z direction. Note that the expression “between the heating surface 621 and the modeling surface 321” does not include the same position as the heating surface 621 or the same position as the modeling surface 321.

The nozzle 61 may be positioned in the through hole 601 other than during modeling. In the embodiment, under control of the control unit 500, the modeling unit 200 is moved above the first heating unit 600 by a fourth electric actuator 440 illustrated in FIG. 1. With this, the nozzle 61 is moved above the first heating unit 600. In this manner, the fourth electric actuator 440 performs switching between a state in which the nozzle 61 is positioned in the through hole 601 by moving the modeling unit 200 along the Z direction and a retraction state being a state in which the nozzle 61 is positioned above the first heating unit 600 instead of being positioned in the through hole 601. In the following description, moving the nozzle 61 above the first heating unit 600 is also referred to as “retracting the nozzle 61”. Note that, in another embodiment, for example, the fourth electric actuator 440 may be configured to perform switching between the state in which the nozzle 61 is positioned in the through hole 601 and the retraction state by moving the first heating unit 600 along the Z direction with respect to the modeling unit 200.

The first heater 610 illustrated in FIG. 5 is configured by a rubber heater having a rectangular plate-like shape. The first heater 610 is electrically coupled to the control unit 500 via a wiring line omitted in illustration. An output and a temperature of the first heater 610 is controlled by the control unit 500. In another embodiment, for example, the first heater 610 may be configured by a halogen heater, a nichrome wire heater, a carbon heater, or the like. The top surface of the first heater 610 is covered with a heat insulating material 650.

In the embodiment, the heating plate 620 has a rectangular plate-like shape. The lower surface of the heating plate 620 forms the heating surface 621. The heating surface 621 refers to a surface of the surfaces of the first heating unit 600, which is close to the modeling surface 321. The area of the heating surface 621 is larger than the area of the modeling surface 321. the first heater 610 is arranged on the heating plate 620. The first heater 610 is bonded to the upper surface of the heating plate 620. The heating plate 620 supplies the heat, which is supplied from the first heater 610, to the modeling layer via the heating surface 621.

The first supporting unit 700 includes a supporting member 710 and the adjustment mechanism 800 configured to adjust a posture of the first heating unit 600.

The supporting member 710 is fixed so that the relative position of the supporting member 710 with respect to the stage 300 is changed together with that of the nozzle 61. The supporting member 710 of the embodiment includes a fixing plate 711 and a pair of arm portions 730. The fixing plate 711 has a rectangular plate-like shape elongated in the X direction, and is fixed to the movable portion 431 so that the plate surface extends along the X direction and the Z direction and the longitudinal direction extends along the X direction. The arm portions 730 are fixed to the fixing plate 711 so as to extend from the fixing plate 711 toward the −Y direction and face each other in the X direction.

The adjustment mechanism 800 is configured by three suspension portions 810 included in the first supporting unit 700. Of the three suspension portions 810, a first suspension portion 810A supports the end portion of the first heating unit 600 in the Y direction by suspending the center portion of the end portion in the X direction. More specifically, the first suspension portion 810A supports and suspends the first heating unit 600 in the −Z direction from the center portion of the fixing plate 711 in the X direction. A second suspension portion 810B and a third suspension portion 810C support the −Y side of the first heating unit 600 with respect to the center position in the Y direction. More specifically, the second suspension portion 810B supports and suspends the first heating unit 600 in the −Z direction from the arm portions 730 arranged on the −X side. The third suspension portion 810C supports and suspends the first heating unit 600 in the −Z direction from the arm portions 730 arranged on the +X side. Each of the suspension portions 810 is configured so that the length along the Z direction is adjustable. For example, each of the suspension portions 810 includes a linear cylinder including a ball screw and a motor. When the control unit 500 controls the linear cylinder, the length of each of the suspension portions 810 is adjusted. The linear cylinder may be driven by pneumatic or hydraulic pressure. Note that, in the first embodiment, the length of the suspension portion 810 may by adjusted manually.

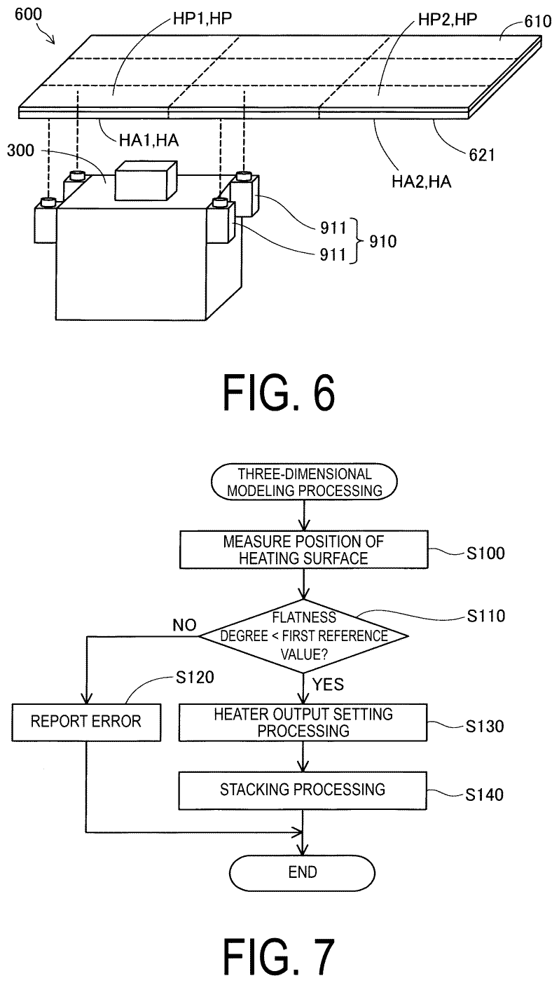

FIG. 6 is an explanatory diagram illustrating the first heating unit 600 and a first sensor 910 in the first embodiment. In FIG. 6, the through hole 601 formed in the first heating unit 600 is omitted. The stage 300 having a rectangular shape is provided with the first sensor 910 being a measurement unit that measures a distance from the stage 300 to the heating surface 621. The first sensor 910 of the embodiment includes four laser displacement meters 911 that are respectively provided at the four corners of the stage 300. The laser displacement meter 911 is capable of measuring the distance from the stage 300 to the heating surface 621 in a non-contact manner. The control unit 500 moves the stage 300 relatively in the X direction and the Y direction with respect to the heating surface 621. With this, the height of the entire heating surface 621 can be measured successively by using the first sensor 910. A measurement range of each of the laser displacement meters 911 is determined individually in advance. In the embodiment, the measurement region of the heating surface 621 is divided into four in the plane direction, and one laser displacement meter 911 is allocated to each measurement region. In this manner, the measurement regions are allocated individually to the plurality of laser displacement meters 911. With this, even when a movement amount of the stage 300 is limited, the height of the entire heating surface 621 can be measured. The boundary portions of the measurement regions overlap with each other. The control unit 500 corrects a measurement value measured by each of the laser displacement meters 911, based on a measurement value of each of the laser displacement meters 911, which is measured in the overlapping measurement region. With this, a wide measurement area can be measured accurately by using the plurality of laser displacement meters 911. The control unit 500 is capable of causing the display unit 550 to display the distance that is measured by using the first sensor 910.

The heating surface 621 are divided into a plurality of heating regions HA. The plurality of heating regions HA includes at least a first heating region HAI and a second heating region HA2. In the embodiment, the heating surface 621 includes nine heating regions HA. The first heater 610 includes a plurality of heater portions HP corresponding to the respective heating regions HA. The control unit 500 is capable of controlling an output of each of the heater portions HP individually. The heater portion HP includes a first heater portion HP1 arranged at the first heating region HA1 and a second heater portion HP2 arranged at the second heating region HA2.

FIG. 7 is a flowchart of the three-dimensional modeling processing executed by the control unit 500. In step S100, the control unit 500 uses the first sensor 910 to measure a position of the heating surface 621. Specifically, the control unit 500 uses the first sensor 910 to measure the position of the entire heating surface 621, in other words, the distance from the stage 300 to the entire heating surface 621 while moving the stage 300 relatively in the plane direction with respect to the heating surface 621. In step S100, the control unit 500 measures the position of the heating surface 621 after the nozzle 61 is retracted.

In step S110, the control unit 500 determines whether a flatness degree of the heating surface 621 is less than a first reference value. The flatness degree of the heating surface 621 is a value indicating a difference between the maximum height and the minimum height of the heating surface 621. Thus, as the flatness degree is increased, a height difference of the heating surface 621 is increased. When the flatness degree is not less than the first reference value, in other words, the flatness degree is equal to or more than the first reference value, the control unit 500 reports an error in step S120. For example, the control unit 500 causes the display unit 550 to display that the flatness degree of the heating surface 621 is equal to or more than the first reference value. With this, a user can be prompted to adjust the posture of the first heating unit 600. After the error is reported, the control unit 500 terminates the three-dimensional modeling processing. Note that the control unit 500 may report an error by sound voice.

When it is determined that the flatness degree of the heating surface is less than the first reference value in step S110, the control unit 500 executes heater output setting processing in step S130.

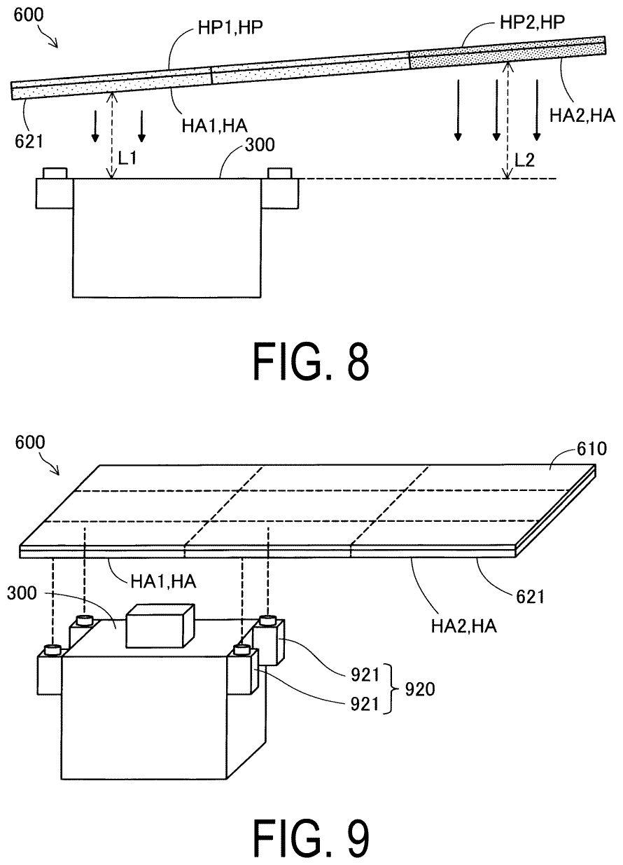

FIG. 8 is an explanatory diagram of the heater output setting processing. As illustrated in FIG. 5, the three-dimensional modeling device 100 includes the adjustment mechanism 800 capable of adjusting the posture of the first heating unit 600. However, because the first heating unit 600 is larger than the stage 300 in the horizontal direction, it may be difficult to arrange the first heating unit 600 accurately in parallel to the stage 300. Consequently, as illustrated in FIG. 8, the first heating unit 600 may be arranged to be inclined with respect to the stage 300. In view of this, in the heater output setting processing in step S130, the control unit 500 changes the output of the heater portion HP corresponding to each of the heating regions HA, based on the distance of each of the heating regions HA from the stage 300. Specifically, the control unit 500 sets a smaller output for the heater portion HP arranged at the heating region HA as the heating region HA has a smaller representative distance from the stage 300. In other words, the control unit 500 sets a larger output for the heater portion HP arranged at the heating region HA as the heating region HA has a larger representative distance from the stage 300. In the embodiment, the representative distance is an average distance of the heating region HA from the stage 300. For example, as illustrated in FIG. 8, when a first distance L1 being a representative distance from the stage 300 to the first heating region HA1 is smaller than a second distance L2 being a representative distance from the stage 300 to the second heating region HA2, the control unit 500 sets the output of the first heater portion HP1 arranged at the first heating region HA1 to an output lower than the output of the second heater portion HP2 arranged at the second heating region HA2. The heater output setting processing in step S130 is also referred to as first processing. Note that the representative distance is not limited to the average distance of the heating region HA, and may be a maximum distance or a minimum distance of the heating region HA, or a distance at the center position of the heating region HA.

After the output of each of the heater portions is set in step S130 in FIG. 7, the control unit 500 executes stacking processing in step S140. The stacking processing is processing for stacking a modeling layer on the modeling surface 321 and modeling a three-dimensional modeling object, and is executed according to modeling data by the control unit 500 controlling the moving unit 400 and the plasticizing unit 30 and causing the nozzle 61 to eject the plasticized material onto the stage 300 while moving the nozzle 61. Prior to the three-dimensional modeling processing, the control unit 500 acquires the modeling data from another device or a recording medium, and stores the modeling data in a memory. In the modeling data, movement paths of the nozzle 61 and an ejection amount of the plasticized material in each of the movement paths are recorded. Prior to the stacking processing, the control unit 500 positions the nozzle 61, which is retracted in step S100, in the through hole 601. During the stacking processing, the modeling layer modeled on the stage 300 is heated by each of the heater portions HP for which the output is set in step S130. Adhesion strength between the modeling layers is enhanced by heating the modeling layers during modeling, and the modeling accuracy of the three-dimensional modeling object is improved. Note that the control unit 500 turns off distance measurement by the first sensor 910 during the stacking processing.

According to the first embodiment described above, when it is determined, based on measurement of the position of the heating surface 621 by using the first sensor 910, that the distance between the first heating region HA1 and the stage 300 is the first distance L1 and the distance between the second heating region HA2 and the stage is the second distance L2 larger than the first distance L1, the control unit 500 sets the output of the first heater portion HP1 lower than the output of the second heater portion HP2. Thus, the temperature distribution between the heating surface 621 and the stage 300 can be uniformed, and hence heating unevenness in the modeling object on the stage 300 can be suppressed.

Further, in the embodiment, when it is determined, based on measurement of the position of the heating surface 621 by using the first sensor 910, that the flatness degree of the heating surface 621 is equal to or more than the first reference value that is determined in advance, the control unit 500 reports an error without executing the heater output setting processing and the stacking processing, and stops the three-dimensional modeling processing. Thus, when the flatness degree of the heating surface 621 is large, and there is a possibility that heating unevenness cannot be avoided even by adjusting the output of each of the heater portions HP, unnecessary modeling of the modeling object can be suppressed.

Note that, in the first embodiment, the processing in step S110 and step S120 illustrated in FIG. 7 may be omitted.

### B. Second Embodiment

FIG. 9 is an explanatory diagram illustrating a schematic configuration of the first heating unit 600 and a second sensor 920 of a second embodiment. In the first embodiment, the three-dimensional modeling device 100 includes the first sensor 910 as a measurement unit. In contrast, in the second embodiment, the three-dimensional modeling device 100 includes the second sensor 920 as a measurement unit. Note that, in the second embodiment, it is assumed that the length of each of the suspension portions 810 can be adjusted by the control unit 500 and an output for each of the heater portions HP cannot be adjusted in the first heater 610.

In the second embodiment, the stage 300 having a rectangular shape is provided with the second sensor 920 that measures a temperature of the heating surface 621. The second sensor 920 of the embodiment is configured by four non-contact thermometers 921 that are respectively provided at the four corners of the stage 300. The control unit 500 moves the stage 300 relatively in the X direction and the Y direction with respect to the heating surface 621. With this, the temperature of the entire heating surface 621 can be measured successively by using the second sensor 920. A measurement range of each of the non-contact thermometers 921 is determined individually in advance. In the embodiment, the measurement region of the heating surface 621 is divided into four in the plane direction, and one non-contact thermometer 921 is allocated to each of the measurement regions. In this manner, the measurement regions are allocated individually to the plurality of non-contact thermometers 921. With this, even when a movement amount of the stage 300 is limited, the temperature of the entire heating surface 621 can be measured. The boundary portions of the measurement regions overlap with each other. The control unit 500 corrects a measurement value measured by each of the non-contact thermometers 921, based on a measurement value of each of the non-contact thermometers 921, which is measured in the overlapping measurement region. With this, a wide measurement area can be measured accurately by using the plurality of non-contact thermometers 921. The control unit 500 is capable of causing the display unit 550 to display the temperature that is measured by using the second sensor 920.

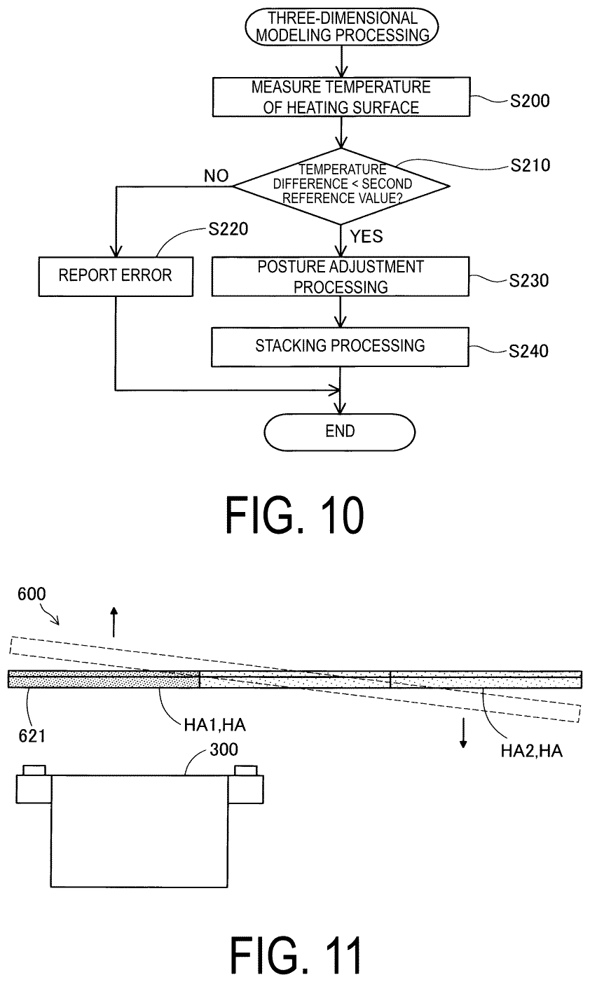

FIG. 10 is a flowchart of the three-dimensional modeling processing executed by the control unit 500 in the second embodiment. After the output of the first heater 610 is set to the output that is determined in advance, the control unit 500 uses the second sensor 920 to measure the temperature of the heating surface 621 in step S200. Specifically, the control unit 500 uses the second sensor 920 to measure the temperature of the entire heating surface 621 while moving the stage 300 relatively in the plane direction with respect to the heating surface 621. After the nozzle 61 is retracted, the control unit 500 executes measurement of the temperature of the heating surface 621 in step S200.

In step S210, the control unit 500 determines whether a temperature difference at the heating surface 621 is less than a second reference value. The temperature difference of the heating surface 621 is a value being a difference between the maximum temperature and the minimum temperature of the heating surface 621. When the temperature difference is not less than the second reference value, in other words, the temperature difference is equal to or more than the second reference value, the control unit 500 reports an error in step S220. For example, the control unit 500 causes the display unit 550 to display that the temperature difference of the heating surface 621 is equal to or more than the first reference value. With this, a user can be notified that a malfunction or a failure occurs in the first heating unit 600. After the error is reported, the control unit 500 terminates the three-dimensional modeling processing.

When it is determined that the temperature difference of the heating surface 621 is less than the second reference value in step S210, the control unit 500 executes the posture adjustment processing in step S230.

FIG. 11 is an explanatory diagram of the posture adjustment processing. In the posture adjustment processing, the control unit 500 controls the adjustment mechanism 800 so that the distance of the heating region HA from the stage 300 in the vertical direction is increased as the heating region HA has a higher representative temperature. With this, the posture of the first heating unit 600 is adjusted. In other words, in the posture adjustment processing, the control unit 500 controls the adjustment mechanism 800 so that the distance of the heating region HA from the stage 300 in the vertical direction is reduced as the heating region HA has a lower representative temperature. With this, the posture of the first heating unit 600 is adjusted. In the embodiment, the representative temperature is an average temperature in the heating region HA. For example, as illustrated in FIG. 11, when the temperature of the first heating region HA1 is higher than the temperature of the second heating region HA2, the control unit 500 controls the adjustment mechanism 800 so that the position of the first heating region HA1 is higher than the position of the second heating region HA2. With this, the posture of the first heating unit 600 is adjusted. The posture adjustment processing in step S230 is also referred to as second processing. Note that the representative temperature is not limited to the average temperature of the heating region HA, and maybe a maximum temperature or a minimum temperature of the heating region HA, or a temperature at the center position of the heating region HA.

In the embodiment, the first heating unit 600 has a plate-like shape. Thus, the control unit 500 cannot adjust the height individually for each of the heating regions HA. Thus, the control unit 500 may adjust the posture of the first heating unit 600 so that, among the heating regions HA, except for the heating region HA positioned at the center of the nine heating regions HA being divided, the height of the heating region HA having the lowest representative temperature is lower than the other heating regions HA or the height of the heating region HA having the highest representative temperature is higher than the other heating regions HA.

After the posture of the first heating unit 600 is adjusted in step S230 in FIG. 10, the control unit 500 executes the stacking processing in step S240. Prior to the stacking processing, the control unit 500 positions the nozzle 61, which is retracted in step S100, in the through hole 601. During the stacking processing, the modeling layer modeled on the stage 300 is heated by the first heating unit 600 in the posture adjusted in step S230. Note that the control unit 500 terns off temperature measurement by the second sensor 920 during the stacking processing.

According to the second embodiment, when it is determined, based on measurement of the temperature of the heating surface 621 by using the second sensor 920, that the temperature of the first heating region HA1 is higher than the temperature of the second heating region HA2, the control unit 500 controls the adjustment mechanism 800 so that the distance between the first heating region HA and the stage 300 is larger than the distance between the second heating region HA2 and the stage 300. Thus, the temperature distribution between the heating surface 621 and the stage 300 can be uniformed, and hence heating unevenness in the modeling object on the stage 300 can be suppressed.

Further, in the embodiment, when it is determined, based on measurement of the temperature of the heating surface 621 by using the second sensor 920, that the temperature difference of the heating surface 621 is equal to or more than the second reference value that is determined in advance, the control unit 500 reports an error without executing the posture adjustment processing and the stacking processing, and thus stops the three-dimensional modeling processing. Thus, when the temperature difference of the heating surface 621 is large, and there is a possibility that heating unevenness cannot be avoided even by adjusting the posture of the first heating unit 600, unnecessary modeling of the modeling object can be suppressed.

Note that, in the second embodiment, the processing in step S210 and step S220 illustrated in FIG. 10 may be omitted. Further, in the second embodiment, it is assumed that the first heater 610 cannot adjust the output for each of the heater portions HP. However, the first heater 610 may be capable of adjusting the output for each of the heater portions HP.

### C: Third Embodiment

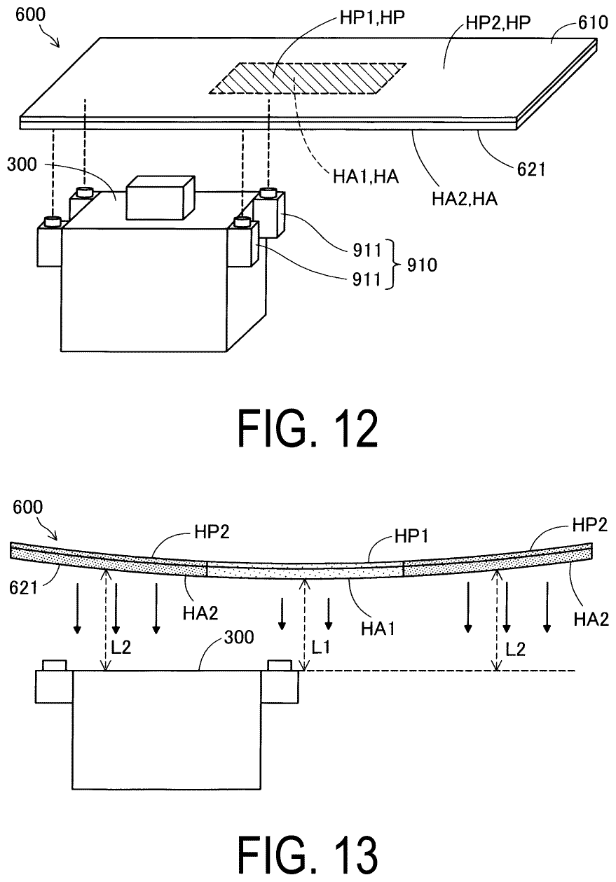

FIG. 12 is an explanatory diagram illustrating a schematic configuration of the first heating unit 600 and the first sensor 910 of a third embodiment. In the third embodiment, on the heating surface 621 of the first heating unit 600, the first heating region HA1 is positioned on the inner side of the second heating region HA2. In FIG. 12, the first heating region HA1 is hatched. As illustrated in FIG. 12, in the embodiment, the second heating region HA2 is arranged to surround the periphery of the first heating region HA1.

In the third embodiment, the control unit 500 executes three-dimensional modeling processing similar to the three-dimensional modeling processing illustrated in FIG. 7 in the first embodiment. In the first embodiment, in the heater output setting processing in step S130 in FIG. 7, the control unit 500 sets a smaller output for the heater portion HP arranged at the heating region HA as the heating region HA has a smaller representative distance from the stage 300. In the embodiment, in the heater output setting processing, the output difference between the first heater portion HP1 and the second heater portion HP2 when the first distance L1 being the representative distance between the first heating region HA1 and the stage 300 is larger than the second distance L2 being the representative distance between the second heating region HA2 and the stage 300 is set smaller than the output difference between the first heater portion HP1 and the second heater portion HP2 when the first distance L1 is smaller than the second distance L2.

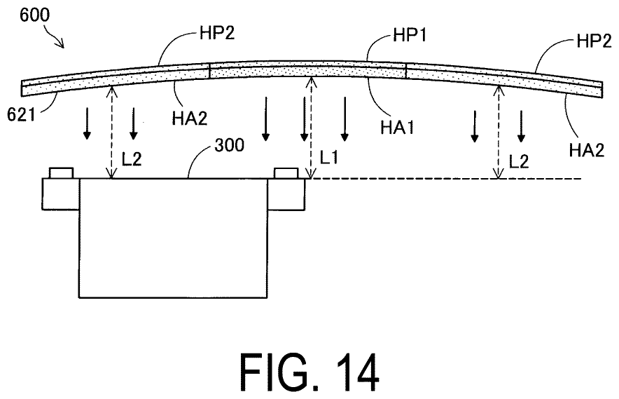

FIG. 13 is a diagram illustrating a state in which the first distance L1 is smaller than the second distance L2. FIG. 14 is a diagram illustrating a state in which the first distance L1 is larger than the second distance L2. In the third embodiment, the output difference between the first heater portion HP1 and the second heater portion HP2, which is illustrated in FIG. 14, is set smaller than the output difference between the first heater portion HP1 and the second heater portion HP2, which is illustrated in FIG. 13. In other words, when the heating surface 621 protrudes upward as illustrated in FIG. 14, the output difference between the first heater portion HP1 and the second heater portion HP2 is set smaller than that in a case in which the heating surface 621 protrudes downward as illustrated in FIG. 13. With this, the temperature difference between the first heating region HA1 and the second heating region HA2 is reduced. With this, when the heating surface 621 protrudes upward, heat accumulation in the vicinity of the first heating region HA1 can be suppressed, and heating unevenness can be suppressed. Note that, as illustrated in FIG. 13, when the heating surface 621 protrudes downward, the heat easily dissipates sideways, and hence heat accumulation is not caused. Thus, when the heating surface 621 protrudes downward, the temperature difference between the first heating region HA1 and the second heating region HA2 may be larger than that in a case in which the heating surface 621 protrudes upward.

Note that, in the third embodiment, as illustrated in FIG. 12, on the heating surface 621, the second heating region HA2 is arranged to surround the periphery of the first heating region HA1. However, arrangement of the first heating region HA1 and the second heating region HA2 is not limited thereto. The first heating region HA1 may be arranged to be sandwiched between two second heating regions HA2 in the X direction or the Y direction. In other words, the entire periphery of the first heating region HA1 may not necessarily be surrounded by the second heating region HA2, and the first heating region HA1 is only required to be positioned on the inner side of the second heating region HA2 in a freely-selected horizontal direction.

### D. Other Embodiments

(D1) In the first embodiment described above, the control unit 500 may have a function of measuring the position of the heating surface 621 by using the first sensor 910 prior to execution of the three-dimensional modeling processing illustrated in FIG. 7, controlling the adjustment mechanism 800, based on the measurement result, to adjust the posture of the first heating unit 600. In other words, the control unit 500 may have a function of executing measurement of the position of the heating surface 621 and adjustment of the posture of the first heating unit 600 at the same time. When the first sensor 910 is a contact-type sensor, it may be difficult to execute position measurement by bringing the sensor into contact with the heating surface 621 and execute adjustment of the posture of the first heating unit 600 at the same time. In contrast, the first sensor 910 is capable of measuring the distance between the heating surface 621 and the stage 300 in a non-contact manner. Thus, the control unit 500 can easily control the adjustment mechanism 800 while measuring the position of the heating surface 621. Adjustment of the posture of the first heating unit 600 is performed simultaneously with measurement of the position of the heating surface 621. With this, the posture of the first heating unit 600 can be adjusted accurately.

(D2) In the first embodiment described above, the control unit 500 may have a function of detecting a foreign matter adhering to the heating surface 621 by using the first sensor 910. For example, during measurement of the heating surface 621, the control unit 500 detects a region having a measurement value that is significantly different from those in the other regions. With this, presence or absence of a foreign matter on the heating surface 621 can be detected. For example, during execution of step S100 in the three-dimensional modeling processing illustrated in FIG. 7, the control unit 500 may execute measurement of the position of the heating surface and detection of a foreign matter at the same time. When a foreign matter is detected, the control unit 500 may cause the display unit 550 to display an error indicating detection of the foreign matter, and may stop three-dimensional modeling processing.

(D3) In each of the embodiments described above, the control unit 500 may analyze modeling data for modeling a modeling object to specify the heating region HA that does not pass over the modeling object during the stacking processing. During the three-dimensional modeling processing, the control unit 500 reduces or turns off the output of the heater portion HP provided at the heating region HA that does not pass over the modeling object. With this, power consumption can be reduced.

(D4) In the embodiment described above, the control unit 500 measures the distance of the entire heating surface 621 from the stage 300 or the temperature of the entire heating surface 621. In contrast, the control unit 500 may analyze the modeling data, may measure the temperature of the heating region HA of the heating surface 621 or the distance thereof from the stage 300 when the heating region HA passes over the modeling object during the stacking processing, and may not measure the temperature or the distance from the stage 300 for the heating region HA that does not pass over.

(D5) The number of laser displacement meters 911 forming the first sensor 910 in the first embodiment and the number of non-contact thermometers 921 forming the second sensor 920 in the second embodiment are not limited to four, and may be one to three, five, or more.

(D6) In the embodiment described above, the first heating unit 600 is supported on the first supporting unit 700 by the three suspension portions 810. In contrast, the number of suspension portions 810 is not limited to three, and maybe four or more.

(D7) In the embodiment described above, the plasticizing unit 30 includes the flat screw. In contrast, the plasticizing unit 30 may include an in-line screw instead of the flat screw, and may plasticize the material by rotating the in-line screw. In this case, the barrel is formed into a cylindrical shape to accommodate the in-line screw, and may be referred to as a cylinder.

(D8) In the embodiment described above, the three-dimensional modeling device 100 includes the two nozzles 61. In contrast, the number of nozzles 61 may be one, three, or more. Further, the three-dimensional modeling device 100 of the embodiment described above includes the two modeling units 200. However, the number of modeling units 200 may be one, three, or more. One modeling unit 200 may include a plurality of nozzles 61.

(D9) In the embodiment described above, the modeling unit 200 is configured as a head that plasticizes a material formed in a pellet form and ejects the material. In contrast, for example, the modeling unit 200 may be configured as a head that plasticizes a material in a filament form and ejects the material.

### E. Other modes

The present disclosure is not limited to the above-described embodiments, and can be realized in various configurations without departing from the spirit of the present disclosure. For example, appropriate replacements or combinations may be made to the technical features in the embodiments which correspond to the technical features in the aspects described below to solve some or all of the problems described above or to achieve some or all of the advantageous effects described above. Further, even when technical characteristics are not described as essential ones in the present specification, it is possible to delete the technical characteristics in the embodiments appropriately.
(1) According to a first mode of the present disclosure, a three-dimensional modeling device is provided. The three-dimensional modeling device including a plasticizing unit configured to plasticize a material to generate a plasticized material, a nozzle configured to eject the plasticized material, a stage including a modeling surface on which the plasticized material is stacked, a moving unit configured to change a relative position between the nozzle and the stage, a first heating unit including a heating surface configured to heat the plasticized material stacked on the stage and having a plate-like shape in which a through hole is formed, at least a part of the nozzle being positioned inside the through hole during modeling of a three-dimensional object, a measurement unit including a first sensor configured to measure a position of the heating surface, and a control unit, wherein the heating surface includes a first heating region and a second heating region, the first heating unit includes a first heater part arranged corresponding to the first heating region and a second heater part arranged corresponding to the second heating region, and the control unit executes first processing for setting an output of the first heater part lower than an output of the second heater part when it is determined, based on measurement of a position of the heating surface, that a distance between the first heating region and the stage is a first distance and a distance between the second heating region and the stage is a second distance larger than the first distance.

According to this mode, the control unit executes the first processing. With this, when the first heating unit heats the modeling object on the stage, heating unevenness can be suppressed.
(2) In the mode described above, the control unit may execute the first processing when it is determined, based on measurement of a position of the heating surface, that a flatness degree of the heating surface is less than a first reference value, and may report an error without executing the first processing when it is determined that the flatness degree is equal to or more than the first reference value. According to this mode, when the flatness degree of the heating surface is such a flatness degree that cannot suppress heating unevenness, an error can be reported.
(3) In the mode described above, the first heating region of the heating surface may be positioned on an inner side of the second heating region. In the first processing, the control unit may reduce an output difference between the first heater part and the second heater part when the first distance is larger than the second distance to be smaller than an output difference between the first heater part and the second heater part when the first distance is smaller than the second distance. According to this mode, it is possible to suppress heat accumulation in the vicinity of the first heating region positioned on the inner side of the second heating region.
(4) In the mode described above, an adjustment mechanism configured to adjust a posture of the first heating unit may further be included. The control unit may control the adjustment mechanism to adjust a posture of the first heating unit, based on a result of measurement of a position of the heating surface. According to this mode, the posture of the first heating unit can be adjusted accurately.
(5) According to a second mode of the present disclosure, a three-dimensional modeling device is provided. The three-dimensional modeling device includes a plasticizing unit configured to plasticize a material to generate a plasticized material, a nozzle configured to eject the plasticized material, a stage including a modeling surface on which the plasticized material is stacked, a moving unit configured to change a relative position between the nozzle and the stage, a first heating unit including a heating surface configured to heat the plasticized material stacked on the stage and having a plate-like shape in which a through hole is formed, at least a part of the nozzle being positioned inside the through hole during modeling of a three-dimensional object, a measurement unit including a second sensor configured to measure a temperature of the heating surface, an adjustment mechanism configured to adjust a posture of the first heating unit, and a control unit, wherein the heating surface includes a first heating region and a second heating region, the first heating unit includes a first heater part arranged corresponding to the first heating region and a second heater part arranged corresponding to the second heating region, and, when it is determined, based on measurement of a temperature of the heating surface, that a temperature of the first heating region is higher than a temperature of the second heating region, the control unit executes second processing for controlling the adjustment mechanism so that a distance between the first heating region and the stage is larger than a distance between the second heating region and the stage.

According to this mode, the control unit executes the second processing. With this, when the first heating unit heats the modeling object on the stage, heating unevenness can be suppressed.
(6) In the mode described above, the control unit may execute the second processing when it is determined, based on measurement of a temperature of the heating surface, that a temperature difference on the heating surface is less than a second reference value, and may report an error without executing the second processing when it is determined that the temperature difference is equal to or more than the second reference value. According to this mode, the temperature difference at the heating surface is such a temperature difference that cannot suppress heating unevenness, an error can be reported.

The present disclosure is not limited to the mode as the three-dimensional modeling device described above, and can be achieved by various modes such as a method of adjusting a three-dimensional modeling device, a computer program for controlling a three-dimensional modeling device, and a non-transitory tangible recording medium on which a computer-readable computer program is recorded.

What is claimed is:

1. A three-dimensional modeling device comprising:
a plasticizing unit configured to plasticize a material to generate a plasticized material;
a nozzle configured to eject the plasticized material;
a stage including a modeling surface on which the plasticized material is stacked;
a moving unit configured to change a relative position between the nozzle and the stage;
a first heating unit including a heating surface configured to heat the plasticized material stacked on the stage and having a plate-like shape in which a through hole is formed, at least a part of the nozzle being positioned inside the through hole during modeling of a three-dimensional object;
a measurement unit including a first sensor configured to measure a position of the heating surface; and
a control unit, wherein
the heating surface includes a first heating region and a second heating region,
the first heating unit includes a first heater part arranged corresponding to the first heating region and a second heater part arranged corresponding to the second heating region, and
the control unit executes first processing for setting an output of the first heater part lower than an output of the second heater part when it is determined, based on measurement of a position of the heating surface, that a distance between the first heating region and the stage is a first distance and a distance between the second heating region and the stage is a second distance larger than the first distance.

2. A three-dimensional modeling device according to claim 1, wherein
the control unit executes the first processing when it is determined, based on measurement of a position of the heating surface, that a flatness degree of the heating surface is less than a first reference value that is determined in advance, and reports an error without executing the first processing when it is determined that the flatness degree is equal to or more than the first reference value.

3. A three-dimensional modeling device according to claim 1, wherein
the first heating region of the heating surface is positioned on an inner side of the second heating region, and
in the first processing, the control unit causes an output difference between the first heater part and the second heater part when the first distance is larger than the second distance to be smaller than an output difference between the first heater part and the second heater part when the first distance is smaller than the second distance.

4. A three-dimensional modeling device according to claim 1, further comprising:
an adjustment mechanism configured to adjust a posture of the first heating unit, wherein
the control unit controls the adjustment mechanism to adjust a posture of the first heating unit, based on a result of measurement of a position of the heating surface.

5. A three-dimensional modeling device comprising:
a plasticizing unit configured to plasticize a material to generate a plasticized material;
a nozzle configured to eject the plasticized material;
a stage including a modeling surface on which the plasticized material is stacked;
a moving unit configured to change a relative position between the nozzle and the stage;
a first heating unit including a heating surface configured to heat the plasticized material stacked on the stage and having a plate-like shape in which a through hole is formed, at least a part of the nozzle being positioned inside the through hole during modeling of a three-dimensional object;
a measurement unit including a second sensor configured to measure a temperature of the heating surface;
an adjustment mechanism configured to adjust a posture of the first heating unit; and
a control unit, wherein
the heating surface includes a first heating region and a second heating region,
the first heating unit includes a first heater part arranged corresponding to the first heating region and a second heater part arranged corresponding to the second heating region, and
when it is determined, based on measurement of a temperature of the heating surface, that a temperature of the first heating region is higher than a temperature of the second heating region, the control unit executes second processing for controlling the adjustment mechanism so that a distance between the first heating region and the stage is larger than a distance between the second heating region and the stage.

6. A three-dimensional modeling device according to claim 5, wherein
the control unit executes the second processing when it is determined, based on measurement of a temperature of the heating surface, that a temperature difference on the heating surface is less than a second reference value that is determined in advance, and reports an error without executing the second processing when it is determined that the temperature difference is equal to or more than the second reference value.
